(19) United States
(12) Patent Application Publication
(10) Pub. No.: US 2016/0131738 A1
(43) Pub. Date: May 12, 2016

(54) Multi-Functional Radar Assembly

(71) Applicant: AIRBUS DEFENCE AND SPACE GMBH, Ottobrunn (DE)

(72) Inventors: Ulrich PRECHTEL, München (DE); Askold MEUSLING, Holzkirchen (DE)

(21) Appl. No.: 14/895,663

(22) PCT Filed: Jun. 2, 2014
(86) PCT No.: PCT/DE2014/000269

§ 371 Date: Dec. 3, 2015

(30) Foreign Application Priority Data
Jun. 5, 2013 (DE) 10 2013 105 809.4

(51) Int. Cl. G01S 7/02; H01Q 3/26; H01Q 21/08

(52) U.S. Cl. CPC G01S 7/02; H01Q 21/08; H01Q 3/26; G01S 2013/0272

(57) ABSTRACT

A radar assembly for transmitting and/or receiving at least one radar beam, includes an antenna assembly, which in turn includes a transmitting antenna device having a number of transmitting antenna elements. A control device generates control signals for the transmitting antenna elements. The antenna assembly also includes a first receiving antenna device having a plurality of receiving antenna elements. The transmitting antenna device includes a first antenna segment and a second antenna segment, the segments being arranged at a distance from one another and each having a plurality of transmitting antenna elements arranged along a rectilinear path.

### BACKGROUND AND SUMMARY OF THE INVENTION

Exemplary embodiments of the invention relate to a radar assembly for emitting and/or receiving at least one radar beam, comprising an antenna assembly. The antenna assembly in turn comprises a transmitting antenna device having a plurality of transmitting antenna elements. For generating drive signals for the transmitting antenna elements, the radar assembly comprises a driving device. The antenna assembly comprises a first receiving antenna device comprising a plurality of receiving antenna elements. The transmitting antenna device comprises a first antenna segment and a second antenna segment, which are arranged in a manner spaced apart from one another and in each case comprise a plurality of transmitting antenna elements arranged along a straight line.

Radar assemblies of the type mentioned above are used in aircraft or ground surveillance radars. They are used, for example, to locate other aircraft and thereby to avoid collisions. The assemblies can also be used for scanning the surface of the earth ahead of the aircraft, for example to provide the pilot with improved information during low-level flight. The automation of landing systems is also simplified by such a radar.

Modern radar systems primarily make it possible to transmit information with high bandwidths between radar systems. By virtue of the possibility of using a strong directional characteristic, spontaneous directional radio links and mesh networks can also be set up as a result.

Radar systems are currently designed for specific requirements, that is to say that they are designed either for large ranges or for instantaneous imaging. Aircraft and helicopters, but also various land applications, often require a plurality of functions in parallel, such that two systems are installed in practice.

AESA radars are known for large ranges. MIMO radars having different thinned antenna assemblies are often used for imaging systems.

German patent document DE 10 2004 040 015 A1 discloses using a transmitting antenna to generate radar signals at different frequencies, the reflections of which are received by means of two receiving antennas aligned parallel to one another, the distance between which is chosen such that the limits of the unambiguity range intersect the sidelobes and that a detection of the reflected object is performed by means of a vectorial sum of the signals of the initial antennas.

European patent document EP 1 784 893 B1 proposes that individual regions of an AESA grid that is usually designed completely with transmitting/receiving antenna elements be designed with purely receiving or purely transmitting antenna elements.

AHMED, S. S., SCHIESSL, A.: “A Novel Active Real-Time Digital-Beamforming Imager for Personnel Screening”. In: Synthetic Aperture Radar, 2012. EUSAR. 9^{th} European Conference on Date 23-26 Apr. 2012, pages 178-181 and AHMED, S. S. et. al.: “A Novel Fully Electronic Active Real-Time Imager Based on a Planar Multistatic Sparse Array”. In: IEEE TRANSACTION ON MICROWAVE THEORY AND TECHNIQUES, VOL. 59, No. 12, DECEMBER 2011, pages 3567-3576 relate to an MIMO antenna assembly in which in each case two transmitting and receiving element lines are arranged opposite one another in pairs and form a square antenna assembly. The antenna assembly is driven to carry out imaging scanning of an object by means of a driving device. A plurality of antenna assemblies are arranged alongside one another in a plane in order to increase the area covered by the imaging and the resolution.

Exemplary embodiments of the invention are directed to addressing the problem of providing a radar assembly of the type mentioned in the introduction which is useable flexibly in conjunction with a small size.

In accordance with exemplary embodiments each of the antenna segments of the radar assembly, as a result of an interaction of the transmitting antenna elements, in each case forms a group antenna (antenna array/antenna line) by which a common radar beam is in each case generatable, and wherein the driving device is designed for generating the drive signals in such a way that each of the radar beams generated by the antenna segments is separately pivotable.

The radar assembly according to the invention is suitable both for carrying out radar scanning over large distances and for scanning nearby targets with high resolution. By virtue of the fact that only one receiving antenna device is provided, the radar assembly requires significantly less space and has a lower weight than the radar assemblies known hitherto for incorporation into aircraft, a plurality of independent systems usually being used in the known radar assemblies. Furthermore, the receiving antenna device has a simple construction, with the result that it can be provided cost-effectively. By virtue of the fact that the transmitting antenna elements of the transmitting antenna device are arranged in two segments or in two lines, wherein the radar beams generated by the segments are electronically pivotable in each case by means of the driving device by the formation of a group antenna, a gain in range is obtained compared with a traditional MIMO assembly. The construction is simplified compared with a traditional AESA assembly, since the transmitting antenna elements and the receiving antenna elements are completely separated.

In order to improve the resolution and the range, the antenna assembly can comprise a second receiving antenna device.

The receiving antenna devices can be arranged on mutually opposite sides of the transmitting antenna device. A particularly compact design is achieved as a result. Furthermore, the receiving antenna devices in this case have the same alignment as the transmitting antenna device, with the result that the analytical requirements made of image reconstruction are reduced.

The transmitting antenna device can comprise a third antenna segment. An additional antenna segment can increase the range and/or the resolution of the radar assembly.

The third antenna segment can be arranged between the first antenna segment and the second antenna segment. A particularly compact design is achieved as a result.

At least one of the antenna segments can comprise a plurality of subsegments which can in each case form a group antenna. This makes it possible to generate simultaneously further independent radar beams, distinguishable by coding or modulation, and thus to carry out a plurality of different radar tasks independently of one another. The driving device can be designed in such a way that each of the subsegments is separately pivotable. In one design, one of the antenna elements comprises two subsegments.

A plurality of the transmitting antenna elements can be connected to one another by a distribution network to form an antenna segment and/or a subsegment. Such a distribution network simplifies the driving.

In a further design, the radar assembly comprises a driving device comprising a signal shaping device for driving one of the antenna segments for each of the transmitting antenna elements. Such a driving device makes it possible, besides direction control of the radar beam that can be carried out particularly precisely and simply, to alter the division of the subsegments flexibly during operation.

The radar assembly can comprise a plurality of antenna assemblies, in particular two antenna assemblies. A further increase in range and/or resolution can be obtained as a result. Depending on the alignment of the antenna assemblies, the viewing angle of the radar assembly can also be increased.

The antenna assemblies are advantageously arranged in a manner adjoining one another. This facilitates the joining together of the radar images determined by the different antenna assemblies.

The antenna assemblies can be inclined relative to one another, in particular can form an angle of between 185° and 270° between them. As a result, different viewing angles that are frequently used can be covered in a simplified manner. An angle of between 90° and 270° is also conceivable.

In one particularly advantageous design, the antenna assemblies form an angle of between 120° and 170° between them. Such a radar assembly is advantageous particularly for aircraft if the latter require a flight radar and a landing radar.

### BRIEF DESCRIPTION OF THE DRAWING FIGURES

The invention is explained in greater detail below on the basis of exemplary embodiments illustrated schematically in the accompanying drawings. In the figures specifically:

FIG. 1 shows the construction of a first embodiment of the radar assembly;

FIG. 2 shows the construction of a second embodiment of the radar assembly;

FIG. 3 shows the construction of a third embodiment of the radar assembly;

FIG. 4 shows the construction of a fourth embodiment of the radar assembly;

FIG. 5 shows a detail of possible driving of the third embodiment;

FIG. 6 shows a detail of possible driving of the first to fourth embodiments;

FIG. 7 shows a detail of possible driving of the first to fourth embodiments;

FIG. 8 shows a front view of the construction of a fifth embodiment of the radar assembly and

FIG. 9 shows a side view of the radar assembly from FIG. 8.

### DETAILED DESCRIPTION

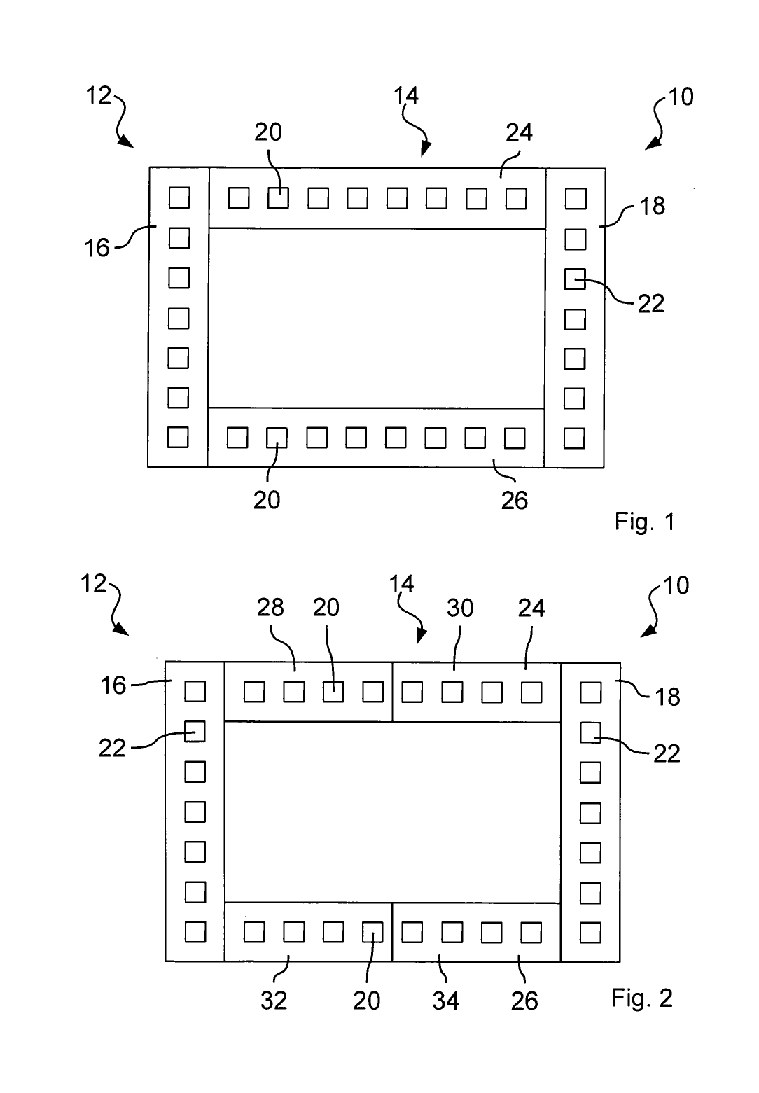

FIG. 1 shows a first embodiment of a radar assembly 10 having an antenna assembly 12. The antenna assembly 12 comprises a transmitting antenna device 14 and also a first receiving antenna device 16 and a second receiving antenna device 18.

The first receiving antenna device 16 and the second receiving antenna device 18 are structurally identical and are arranged on mutually opposite sides of sides of the transmitting antenna device 14 in such a way that the transmitting antenna device 14 lies between the first receiving antenna device 16 and the second receiving antenna device 18. The first receiving antenna device 16 and the second receiving antenna device 18 can be arranged, as shown here, in each case in a manner bearing against the transmitting antenna device 14.

The transmitting antenna device 14 comprises a multiplicity of transmitting antenna elements 20, which, as shown here, can be arranged in a rectangular grid. Each of the transmitting antenna elements 20 is drivable by means of a distribution network (not shown).

The receiving antenna devices 16, 18 in each case comprise a multiplicity of receiving antenna elements 22 arranged along a straight line.

By virtue of the fact that the receiving antenna devices 16, 18 comprise receiving antenna elements 22 specialized for receiving radar signals, complex structures, for example T/R switches, can be dispensed with. The provision of receiving antenna devices 16, 18 thus constitutes a low outlay.

The transmitting antenna elements 20 are supplied with drive signals by a driving device 42, as is illustrated by way of example in FIGS. 5 to 7. The driving device 42 allows a radar beam generated by the transmitting antenna elements 20 of the transmitting antenna device 14 to be pivoted. For this purpose, the transmitting antenna elements 20 are driven by the driving device 42 in such a way that they form a group antenna.

The transmitting antenna device 14 comprises a first antenna segment 24 and a second antenna segment 26. Each of the antenna segments 24, 26 forms a dedicated group antenna, wherein the radar beams generated by the antenna segments 24, 26 are separately pivotable by means of the driving device 42. The antenna segments 24, 26 are arranged in a manner spaced apart from one another and parallel to one another. The first receiving antenna device 16 and the second receiving antenna device 18 are likewise arranged in a manner spaced apart from one another and parallel to one another. The receiving antenna device 16, 18 and the antenna segments 24, 26 are arranged such that in each case an end of a receiving antenna device 16, 18 and an end of an antenna segment 24, 26 adjoin one another.

In this way, the antenna segments 24, 26 and the receiving antenna devices 16, 18 form a frame or a parallelogram wherein in each case mutually opposite sides fulfill the same function in order in interaction to improve the radar power and resolution.

The antenna segments 24, 26 in each case comprise transmitting antenna elements 20 arranged along a straight line. The transmitting antenna elements 20 are suitable for emitting radar beams, but not for receiving radar beams. Therefore, the antenna segments 24, 26 are also not designed to receive signals. As a result, the production outlay, in a manner similar to that in the receiving antenna devices 16, 18, can be minimized, for example by dispensing with T/R switches. The antenna segments 24, 26 can be produced cost-effectively and compactly.

It goes without saying that, in all the exemplary embodiments, it is possible to equip the receiving antenna devices 16, 18 exclusively with receiving antenna elements 22.

In the case of the second embodiment shown in FIG. 2, the antenna segments 24, 26 are in each case subdivided into smaller antenna groups, which are referred to as subsegments 28, 30, 32, 34. The subsegments 28, 30, 32, 34 in each case comprise one half of the transmitting antenna elements 20 of their respective antenna segment 24, 26. It is conceivable to divide the transmitting antenna elements 20 among the subsegments 28, 30, 32, 34 in a different ratio. It is also possible to provide more than two subsegments 28, 30, 32, 34 per antenna segment 24, 26, in particular 3, 4, more than 3 or more than 4 subsegments 28, 30, 32, 34.

This subdivision into a plurality of subsegments 28, 30, 32, 34 which once again in each case interact as a group antenna and are driven in this way makes it possible to generate a plurality of different radar beams simultaneously by means of the radar assembly 10.

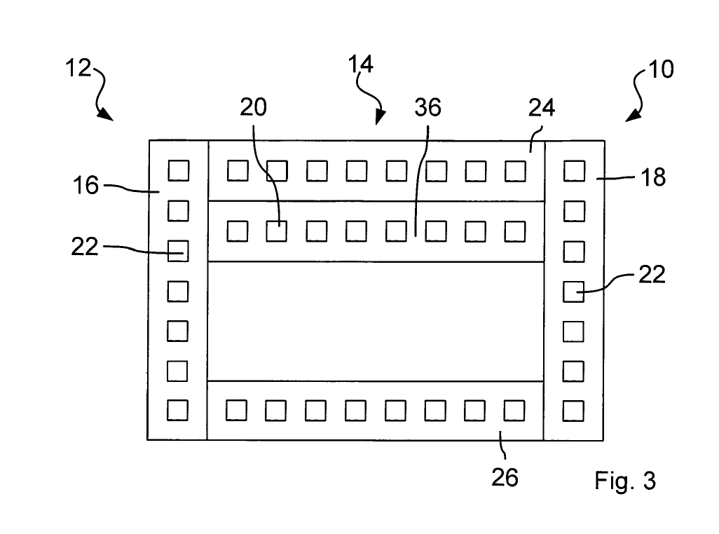

In order to increase the range and/or in order to increase the resolution of the radar assembly 10, a third antenna segment 36 is provided in the embodiment shown in FIG. 3, the construction of the third antenna segment being similar to that of the first and/or second antenna segment 24, 26. The third antenna segment 36 is arranged between the first antenna segment 24 and the second antenna segment 26 and parallel to the antenna segments 24, 26.

The third antenna segment 36 can also be arranged at a distance from the first and second antenna segments 24, 26.

Further antenna segments can be added as necessary. The further antenna segments once again form group antennas, the radar beams of which are separately pivotable.

Each of the antenna segments 24, 26, 36 can be divided into a plurality of independent group antennas, also called subsegments 28, 30, 32, 34. If only a very simple construction is desired and it is possible to dispense with varying the assignment of the transmitting antenna elements 20 to the subsegments 28, 30, 32, 34 after production, it is possible to integrate a corresponding distribution network fixedly into the antenna segments 24, 26, 36.

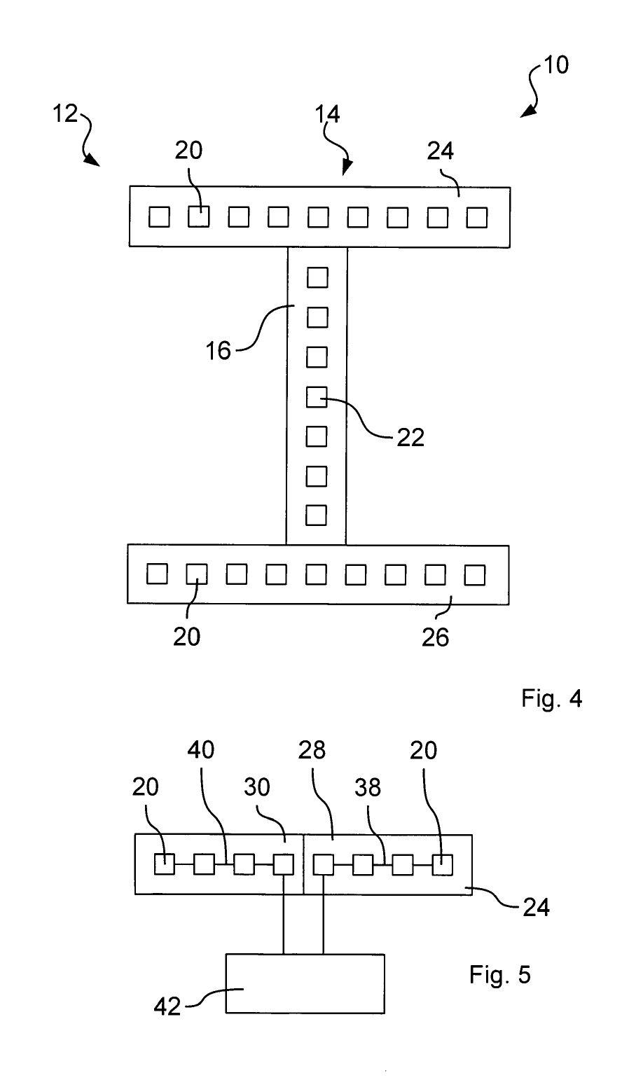

In the case of the fourth embodiment shown in FIG. 4, the antenna assembly 12 comprises only one first receiving antenna device 16 besides the transmitting antenna device 14 having the first antenna segment 24 and the second antenna segment 26. The receiving antenna device 16 is arranged perpendicularly to the antenna segments 24, 26. Such a construction is particularly cost-effective and simple to produce and has an improved resolution and range in relation to its complexity.

FIG. 5 shows by way of example for the first antenna segment 24 the connection of transmitting antenna elements 20 by means of a first distribution network 38 to form a first subsegment 28 and by means of a second distribution network 40 to form a second subsegment 30.

A driving device 42 is provided for driving the subsegments 28, 30. If the distribution networks 38, 40 already comprise devices for the beam control of the subsegments 28, 30, for example phase shifters, the driving device 42 can be embodied in a comparatively simple fashion. In this regard, for example, provision can be made merely for controlling the beam direction of the subsegments 28, 30 by means of the frequency of the emitted signal.

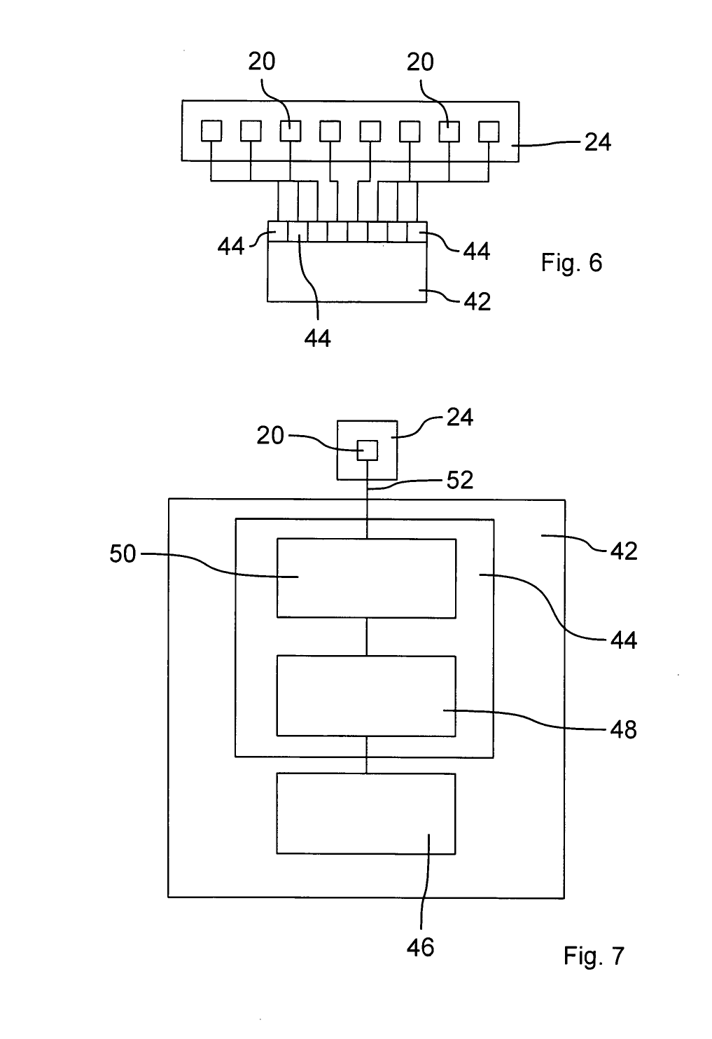

By virtue of the fact that the driving device 42 controls each of the transmitting antenna elements 20 of the antenna segment 24 individually, the exemplary embodiment shown in FIG. 6 is more flexible, but also more complex in terms of construction. The driving device 42 comprises a driving stage 44 for each of the transmitting antenna elements 20, said driving stage providing an output signal for driving the transmitting antenna element 20 respectively assigned thereto.

FIG. 7 illustrates the construction of the driving device 42 by way of example for a transmitting antenna element 20 of the first antenna segment 24. The driving device 42 comprises a control computer 46, which communicates the parameters of the driving signal to be generated to a signal generator 48. Such parameters can comprise, for example, frequency, phase angle and modulation parameters.

A direct digital synthesizer (DDS) is used as signal generator 48 in the present exemplary embodiment. The signal generator 48 generates a digital description of the driving signal, which is converted into the analog driving signal by a digital-to-analog converter (DAC) 50. The driving signal is then transmitted via a distribution network 52 to the first antenna segment 24 and thus to the transmitting antenna element 20. The signal generator 48 and the digital-to-analog converter 50 together form the driving stage 44.

This arrangement is merely one of many possibilities. The driving device 42 or individual parts thereof can also be included in the antenna segments 24, 26, 36. Particularly the signal generator 48 and/or the digital-to-analog converter 50 can be arranged in direct proximity to the assigned transmitting antenna element 20 thereof.

What is common to driving devices 42 according to the invention is that they generate a driving signal, typically by phase control, in such a way that the transmitting antenna elements 20 interacting as a group antenna generate a radar beam that is pivotable (beam pivoting). Each of the antenna segments 24, 26 or each of the subsegments 28, 30, 32, 34 interacts in this case as a separate group antenna and is driven by the driving device 42 as a separate group antenna. As a result, the radar beam generated by each antenna segment 24, 26 or subsegment 28, 30, 32, 34 is separately and autonomously pivotable.

By virtue of the fact that the transmitting antenna elements 20 in the individual antenna segments 24, 26 or subsegments 28, 30, 32, 34 are arranged along a straight line, the individual radar beams are pivotable in each case in a plane. The transmitting antenna elements 20 can be arranged along a horizontally running straight line, such that the beam pivoting can be carried out along the horizontal.

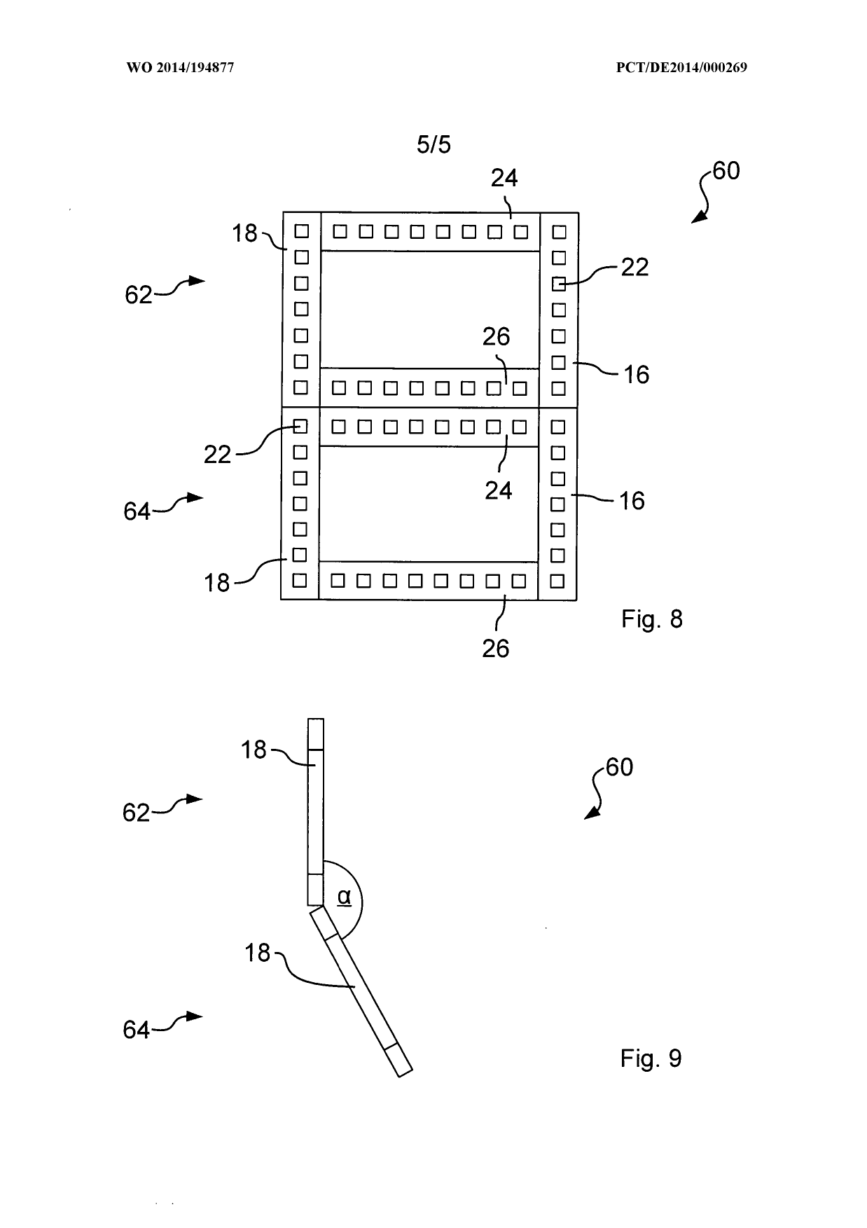

The radar assembly 60 for special requirements as shown in FIG. 8 comprises a first antenna assembly 62 and a second antenna assembly 64. The antenna assemblies 62, 64 correspond in each case to an antenna assembly 12 in terms of their construction. The antenna assemblies 62, 64 are arranged in a manner adjoining one another, such that the receiving antenna elements 22 of the first receiving antenna devices 16 and of the second receiving antenna devices 18 lie in each case in pairs on straight lines in the same plane. The alignment of the receiving antenna devices 16, 18 is therefore identical in the case of both antenna assemblies 62, 64 in plan view. The antenna segments 24, 26 are aligned parallel to one another.

As shown in FIG. 9, the antenna assemblies 62, 64 form an angle a, here approximately 150°, between them. As a result of this different alignment, the range visible to the radar assembly 60 can be enlarged and adapted to the respective task of the radar assembly 60.

Although the statements made here are related only to the first antenna segment 24 in part in order to avoid repetition, they are applicable not just to the first antenna segment 24 but to any desired antenna segment 24, 26, 36.

The division into subsegments 28, 30, 32, 34 is also possible if the transmitting antenna device 14 not only consists of individual antenna segments 24, 26, 36 comprising transmitting antenna elements 20 arranged in each case along a straight line, but rather comprises an array having a multiplicity of transmitting antenna elements 20 arranged in a grid.

The subsegments 28, 30, 32, 34 need not necessarily comprise continuous regions. It is likewise possible, for example, to assign the transmitting antenna elements 20 alternately to different subsegments 28, 30, 32, 34. Vertical or horizontal subsegments 28, 30, 32, 34 or a checkered pattern can be produced as a result.

The receiving antenna devices 16, 18 comprise connecting means by which the receiving antenna elements 22 are connected to a receiving device (not shown). The receiving device analyzes the radar signals received by the receiving antenna elements 22 and obtains therefrom information about objects that reflect radar waves or radar beams. From this information, the receiving device can construct a radar image, for example.

Each of the receiving antenna elements 22 can be connected to a dedicated input of the receiving device. Each input comprises an analog-to-digital converter (ADC) for taking up the received signals, the analog-to-digital converter providing the received signals in digitized form to an analysis device of the receiving device.

In order to ensure the best possible quality of the analysis, it is preferred if the receiving antenna elements 22 of one of the receiving antenna devices 16, 18 can in each case be simultaneously scanned phase-synchronously. Therefore, it is preferred if the connecting means of the receiving antenna devices 16, 18 on the section between the receiving antenna elements 22 and the receiving device ensure a propagation time or phase shift on the transmission path which, if possible, is identical for all the receiving antenna elements 22. If deviations in the propagation time between the connecting means are unavoidable, then these deviations can be taken into account in the analysis up to a certain degree and can thereby be compensated for or extracted computationally.

The present radar assembly 10, 60, with low technical outlay, can both achieve large ranges and yield powerful imaging in the near range.

The multi-functional radar assembly 10, 60 forms a compact radar sensor that can be used for all radar functions that are relevant during flight operation. The use of AESA radar components increases the range and thus the imaging range of a traditional MIMO radar. The combined solution is significantly more cost-effective since the traditional AESA assembly can be reduced in terms of the number of elements to two line-like antenna segments 24, 26 and a complete 3-D image reconstruction can nevertheless be carried out by the addition of in turn only two line-like receiving antenna devices 16, 18. Consequently, the range advantages of AESA are combined with the advantages of the MIMO assembly.

In the first embodiment of the invention, the antenna assembly 12 has a form similar to an MIMO radar assembly (FIG. 1). The transmitting antenna elements 20 of the transmitting antenna device 14, which are arranged in two lines, are electronically pivotable in each case one-dimensionally and thereby allow a gain in range compared with a traditional assembly. By virtue of the fact that the first receiving antenna device 16 and the second receiving antenna device 18 are arranged perpendicularly to the antenna segments 24, 26 of the transmitting antenna device 14, a complete 3-D image reconstruction is possible.

The disadvantage of the pure MIMO radar assembly having purely orthogonal transmitting and receiving antenna elements and the associated driving thereof resides in the limited range, since the transmitting antenna elements do not form group antennas there and are not driven as such. As a result, the latter cannot generate a TX gain from the interconnection of transmitting antenna elements.

The second embodiment of the radar assembly 10, 60 is characterized in that at least one of the antenna segments 24, 26 is subdivided into a plurality of subsegments 28, 30, 32, 34, wherein each subsegment 28, 30, 32, 34 has a dedicated phase center and is autonomously pivotable. The subdivision into subsegments 28, 30, 32, 34 is controllable by means of software during operation, as a result of which the system can be dynamically adapted to different ranges and resolution requirements. Each of the antenna segments 24, 26 is separately controllable, as a result of which it is possible to process image segments in each case with special requirements with regard to range and resolution.

The third embodiment of the radar assembly 10, 60 is to some extent an intermediate form. An increase in range and also an increase in resolution can be achieved simultaneously by means of the third antenna segment 36.

In the case of the fifth embodiment of the radar assembly 10, 60, a plurality of antenna assemblies 62, 64 are arranged at an angle with respect to one another. Depending on the aperture angle of the transmitting antenna elements 20 and the angular position of the antenna assemblies 62, 64 with respect to one another, a region having increased resolution (overlap region of the two antenna assemblies 62, 64) or a very large imaging region (without overlap of the detection regions) can optionally be formed.

If in each case only one viewing direction of the radar assembly 10, 60 is required, the antenna assemblies 62, 64 can be operated from the same driving device 42. Therefore, one application is radars for aircraft which are intended to be aligned toward the front in a flight mode and obliquely downward toward the front in a landing mode.

In the digital design variant of the radar assembly 10, 60, in which the beam pivoting is not carried out by analog phase shifters but rather by digital beam pivoting, in which a digital-to-analog converter (DAC) 50 and, as signal generator 48, a direct digital synthesizer (DDS) are connected to each transmitting antenna element 20, this can be operated such that in short-range operation beam pivoting is not carried out, rather all transmitters are operated with a corresponding coding, for example OFDM, as a result of which a complete imaging becomes possible after only one measurement cycle.

The transmitting antenna elements 20 of the transmitting antenna device 14 can be arranged in a grid. In this case, the transmitting antenna device 14 can be referred to as an antenna grid device.

The antenna segments 24, 26, 36, if their transmitting antenna elements 20 are arranged in each case along a line of said grid of the transmitting antenna device 14 or generally along a straight line, can also be referred to as antenna element lines (antenna line).

The receiving antenna elements 22 can be arranged along a straight line. In this case, the receiving antenna devices 16, 18 can also be referred to as receiving line devices (antenna line).

The antenna segments 24, 26, 36 can be arranged in such a way that they in each case adjoin an end region of the first receiving antenna device 16 and an end region of the second receiving antenna device 18. This arrangement in the form of a rectangle is comparatively stable and simple to fix.

### List of Reference Signs

10 Radar assembly

12 Antenna assembly

14 Transmitting antenna device

16 First receiving antenna device

18 Second receiving antenna device

20 Transmitting antenna element

21 Antenna element

22 Receiving antenna element

24 First antenna segment

26 Second antenna segment

28 First subsegment

30 Second subsegment

32 Third subsegment

34 Fourth subsegment

36 Third antenna segment

38 First distribution network

40 Second distribution network

42 Driving device

44 Driving stage

46 Control computer

48 Signal generator

50 Digital-to-analog converter

52 Distribution network

60 Radar assembly

62 First antenna assembly

64 Second antenna assembly

1-12. (canceled)

13. A radar assembly configured to emit or receive at least one radar beam, the radar assembly comprising:
an antenna assembly comprising a transmitting antenna device having a plurality of transmitting antenna elements,
a driving device configured to generate drive signals for the transmitting antenna elements of the transmitting antenna device,
wherein the antenna assembly comprises a first receiving antenna device comprising a plurality of receiving antenna elements,
wherein the transmitting antenna device comprises a first antenna segment and a second antenna segment, wherein the first and second antenna segments are arranged spaced apart from one another, wherein the first and second antenna segments each comprise a plurality of transmitting antenna elements arranged along a straight line,
wherein each of the first and second antenna segments, as a result of an interaction of the transmitting antenna elements, in each case forms a group antenna by which a common radar beam is generatable, and
wherein the driving device is configured to generate the drive signals in such a way that each of the radar beams generated by the antenna segments is separately pivotable.

14. The radar assembly of claim 13, wherein the antenna assembly comprises a second receiving antenna device.

15. The radar assembly of claim 14, wherein the first and second receiving antenna devices are arranged on mutually opposite sides of the transmitting antenna device.

16. The radar assembly of claim 13, wherein the transmitting antenna device comprises a third antenna segment.

17. The radar assembly of claim 16, wherein the third antenna segment is arranged between the first antenna segment and the second antenna segment.

18. The radar assembly of claim 13, wherein at least one of the first and second antenna segments comprises a plurality of subsegments, which form a group antenna, wherein the driving device is configured to separately pivot each of the subsegments.

19. The radar assembly of claim 13, wherein the driving device comprises a signal shaping device for each of the transmitting antenna elements.

20. The radar assembly of claim 13, wherein the plurality of the transmitting antenna elements are connected to one another by a distribution network to form an antenna segment and/or a subsegment.

21. The radar assembly of claim 13, wherein the radar assembly comprises at least two antenna assemblies.

22. The radar assembly of claim 21, wherein the at least two antenna assemblies are arranged adjoining one another.

23. The radar assembly of claim 22, wherein the at least two antenna assemblies form an angle a of between 185° and 270° between them.

24. The radar assembly of claim 22, wherein the at least two antenna assemblies form an angle a of between 90° and 170° between them.

25. A radar assembly, comprising:
an antenna assembly comprising
a transmitting antenna comprising a first antenna segment and a second antenna segment, wherein the first ands second antenna segments are arranged spaced apart from one another, wherein the first and second antenna segments each comprise a plurality of transmitting antenna elements arranged along a straight line, wherein each of the first and second antenna segments, as a result of an interaction of the transmitting antenna elements, in each case forms a common radar beam group antenna, and
a first receiving antenna comprising a plurality of receiving antenna elements,
an antenna driver configured to generate drive signals for the transmitting antenna elements of the transmitting antenna device in such a way that each of the radar beams generated by the antenna segments is separately pivotable.

26. The radar assembly of claim 25, wherein the antenna assembly comprises a second receiving antenna.

27. The radar assembly of claim 26, wherein the first and second receiving antennas are arranged on mutually opposite sides of the transmitting antenna device.

28. The radar assembly of claim 25, wherein the transmitting antenna comprises a third antenna segment.

29. The radar assembly of claim 28, wherein the third antenna segment is arranged between the first antenna segment and the second antenna segment.
